(19) United States
(12) Patent Application Publication
(10) Pub. No.: US 2012/0051455 A1
(43) Pub. Date: Mar. 1, 2012

(54) TRANSMISSION DEVICE AND TRANSMISSION METHOD

(75) Inventor: Hiroaki Sudo, Kanagawa (JP)

(73) Assignees: NEC Casio Mobile Communicatons, Ltd., Kanagawa (JP); PANASONIC CORPORATION, Osaka (JP)

(21) Appl. No.: 13/266,424

(22) PCT Filed: Apr. 28, 2010
(86) PCT No.: PCT/JP2010/003066

§ 371 Date: Nov. 16, 2011

(30) Foreign Application Priority Data
Apr. 30, 2009 (JP) 2009-110931

(51) Int. Cl. H04L 27/04

(52) U.S. Cl. 375/295

(57) ABSTRACT

A transmission device capable of reducing the information amount of channel quality indicators (CQIs) without deteriorating throughput. In the device, an upper bit transmission control unit (104) sets the transmission intervals between upper bits of the CQIs inputted from an S/P conversion unit (103) to be longer than the transmission intervals between lower bits of the CQIs, and a lower bit transmission control unit (105) sets the transmission intervals between the lower bits of the CQIs inputted from the S/P conversion unit (103). Then, a transmission unit (107) transmits the CQI on the basis of the transmission intervals respectively set by the upper bit transmission control unit (104) and the lower bit transmission control unit (105).

### TECHNICAL FIELD

The present invention relates to a transmitting apparatus and a transmission method.

### BACKGROUND ART

Currently, the third generation partnership project (3GPP) standard is considering a technique of transmitting a transmission rate request signal (referred to as a channel quality indicator (CQI) in the 3GPP standard) which is a control signal for requesting setting of a transmission rate from a transmitting apparatus (for example, a communication terminal apparatus) to a receiving apparatus (for example, a base station apparatus). The receiving apparatus selects a transmission rate according to the received CQI.

As a conventional method of transmitting the transmission rate request signal, there is a method in which a transmission time for transmitting the transmission rate request signal is fixed and a transmitting apparatus transmits all bits of the transmission rate request signal when the fixed transmission time comes (for example, see Non-Patent Literature 1).

### CITATION LIST

### Non-Patent Literature

### NPL 1

3GPP TS25.214, section 6A.1.2

### SUMMARY OF INVENTION

### Technical Problem

However, the conventional technique has a problem in that the amount of transmission rate request signal information increases on a channel from the transmitting apparatus to the receiving apparatus. When the amount of transmission rate request signal information increases, the transmitting apparatus increasingly consumes power for transmitting the transmission rate request signal. Further, when the amount of transmission rate request signal information increases, the amount of interference from transmission rate request signals that influences another terminal increases.

Thus, in order to reduce the amount of transmission rate request signal information, it is considered that the transmitting apparatus increases a transmission interval between transmission times fixedly set for the transmission rate request signal. However, channel state changes from time to time. For this reason, as the transmission interval of the transmission rate request signal increases, the receiving apparatus may have an error occurring between channel state at the time when the transmission rate request signal is received and an actual channel state at the real time. That is, the degree of accuracy of the transmission rate request signal becomes worse. That is, the amount of transmission rate request signal information is reduced, but the receiving apparatus may be unable to select an appropriate transmission rate with respect to the transmitting apparatus, and the throughput may be lowered.

As described above, there is a trade-off relation between the magnitude of decrease in the amount of transmission rate request signal information and throughput.

It is therefore an object of the present invention to provide a transmitting apparatus and a transmission method which are capable of reducing the amount of transmission rate request signal information without lowering the throughput.

### Solution to Problem

A transmitting apparatus according to the present invention includes a control section that sets a first transmission interval of an upper bit of a control signal to be longer than a second transmission interval of a lower bit of the control signal and a transmitting section that transmits the control signal based on the set first transmission interval and the set second transmission interval.

A transmission method of the present invention includes setting a first transmission interval of an upper bit of a control signal to be longer than a second transmission interval of a lower bit of the control signal and transmitting the control signal based on the set first transmission interval and the set second transmission interval.

### Advantageous Effects of Invention

According to the present invention, it is possible to reduce the amount of transmission rate request signal information without lowering the throughput.

### BRIEF DESCRIPTION OF DRAWINGS

FIG. 1 is a block diagram illustrating a configuration of a transmitting apparatus according to Embodiment 1 of the present invention;

FIG. 2 is a diagram illustrating a transmission process of a CQI according to Embodiment 1 of the present invention;

FIG. 3 is a block diagram illustrating a configuration of a transmitting apparatus according to Embodiment 2 of the present invention;

FIG. 4 is a diagram illustrating a transmission process of a CQI according to Embodiment 2 of the present invention;

FIG. 5 is a diagram illustrating a subcarrier group according to Embodiment 2 of the present invention;

FIG. 6 is a block diagram illustrating a configuration of a transmitting apparatus according to Embodiment 3 of the present invention;

FIG. 7 is a diagram illustrating a transmission process of a CQI according to Embodiment 3 of the present invention;

FIG. 8 is a block diagram illustrating a configuration of a transmitting apparatus according to Embodiment 4 of the present invention; and

FIG. 9 is a diagram illustrating another transmission process of a CQI according to the present invention.

### DESCRIPTION OF EMBODIMENTS

Hereinafter, embodiments of the present invention will be described in detail with reference to the accompanying drawings. In the following description, “CQI” refers to the transmission rate request signal.

### Embodiment 1

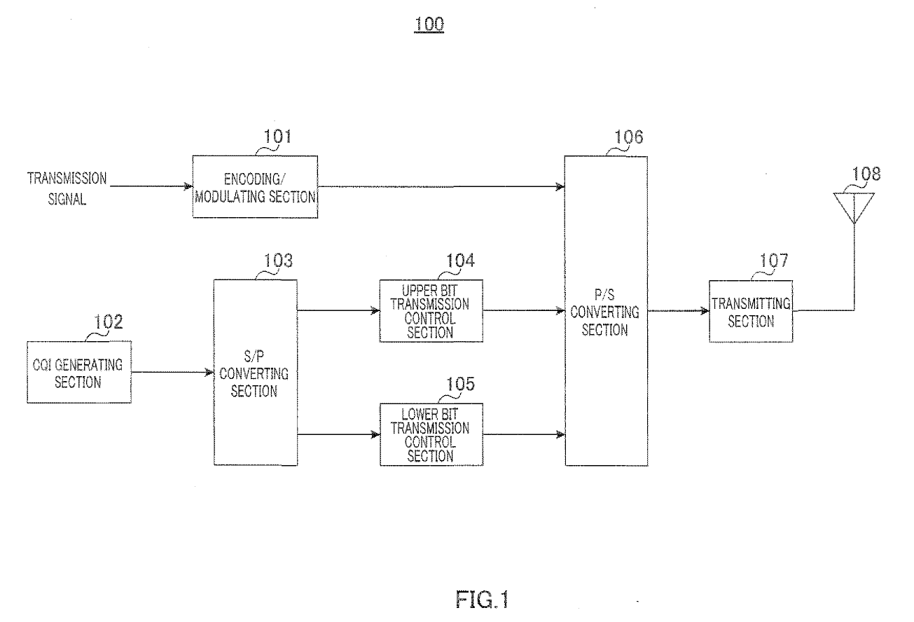

FIG. 1 illustrates a configuration of a transmitting apparatus according to the present embodiment. In transmitting apparatus 100 illustrated in FIG. 1, encoding/modulating section 101 executes an encoding process and a modulating process on a transmitting signal. Then, encoding/modulating section 101 outputs the modulated transmitting signal to parallel/serial (P/S) converting section 106.

CQI generating section 102 generates a CQI that is a control signal representing information for requesting the transmission rate according to the channel state of transmitting apparatus 100. Here, the generated CQI is represented by a plurality of bits. Then, CQI generating section 102 outputs the generated CQI to serial/parallel (S/P) converting section 103.

S/P converting section 103 converts the CQI input in series from CQI generating section 102 into parallel data. Further, S/P converting section 103 divides the converted parallel CQI into upper bits and lower bits. Then, S/P converting section 103 outputs CQI-upper bits to upper bit transmission control section 104 and outputs CQI-lower bits to lower bit transmission control section 105.

Upper bit transmission control section 104 and lower bit transmission control section 105 function as a transmission control section for deciding the transmission time of the CQI. Upper bit transmission control section 104 decides the transmission time of CQI-upper bits input from S/P converting section 103. Here, upper bit transmission control section 104 sets an transmission interval of CQI-upper bits to be longer than an transmission interval of CQI-lower bits set by lower bit transmission control section 105, which will be described later. Then, upper bit transmission control section 104 outputs CQI-upper bits to P/S converting section 106 based on the set transmission interval.

Lower bit transmission control section 105 decides the transmission time of CQI-lower bits input from S/P converting section 103. Here, lower bit transmission control section 105 sets the transmission interval of CQI-lower bits. Then, lower bit transmission control section 105 outputs CQI-lower bits to P/S converting section 106 based on the set transmission interval.

P/S converting section 106 converts CQI-upper bits input in parallel from upper bit transmission control section 104 or CQI-lower bits input in parallel from lower bit transmission control section 105 into serial bits. Then, P/S converting section 106 generates a signal of one system including a transmission signal input from encoding/modulating section 101 and either of CQI-upper bits and CQI-lower bits. Then, P/S converting section 106 outputs the generated signal to transmitting section 107.

Transmitting section 107 performs a transmission process on a signal (that is, the signal including the transmission signal and the CQI) input from P/S converting section 106 and transmits the transmission-processed signal through antenna 108. Thus, the CQI-upper bits and the CQI-lower bits are transmitted based on the transmission intervals respectively set by upper bit transmission control section 104 and lower bit transmission control section 105, respectively.

Next, a detailed description will be made in connection with a transmission control process by upper bit transmission control section 104 and lower bit transmission control section 105 of transmitting apparatus 100.

Values represented by the CQI changes according to the channel state. Further, among a plurality of bits representing the CQI, the higher the bit is, the larger a representable value is. That is, when a CQI-upper bit changes, the amount of change of values represented by the CQI is greater than when a CQI-lower bit changes. Thus, the CQI is generally likely to change in order from the lower bit. That is, among a plurality of bits representing the CQI, the lower the bit is, the easier the value frequently changes according to a variation in the channel state (channel variation). That is, the higher a CQI bit is, the less frequently the value changes.

That is, transmitting apparatus 100 can notify a receiving apparatus of the accurate CQI even though the transmission interval for transmitting CQI-upper bits whose value changes little is longer than the transmission interval for transmitting CQI-lower bits whose value is likely to change frequently. That is, transmitting apparatus 100 may set a transmission frequency for transmitting CQI-upper bits to be smaller than a transmission frequency for transmitting CQI-lower bits.

Thus, upper bit transmission control section 104 of transmitting apparatus 100 sets the transmission interval of CQI-upper bits to be longer than the transmission interval of CQI-lower bits. That is, lower bit transmission control section 105 of transmitting apparatus 100 sets the transmission interval of CQI-lower bits to be shorter than the transmission interval of CQI-upper bits.

A detailed description will be made below. In the following description, it is assumed that the number of CQI bits is five (5). Further, S/P converting section 103 outputs the upper three bits among the five bits of the CQI to upper bit transmission control section 104 and outputs the lower two bits among the five bits of the CQI to lower bit transmission control section 105.

Here, it is assumed that, when the value of a CQI increases (or when the value of a CQI decreases), the value of the transmission rate to request increases. For example, the CQI of “00000” (or “11111”) corresponds to a lowest transmission rate, and the CQI of “11111” (or “00000”) corresponds to a highest transmission rate. That is, the CQIs of “00000” to “11111” (or the CQIs of “11111” to “00000”) are associated in an ascending order from the lowest transmission rate.

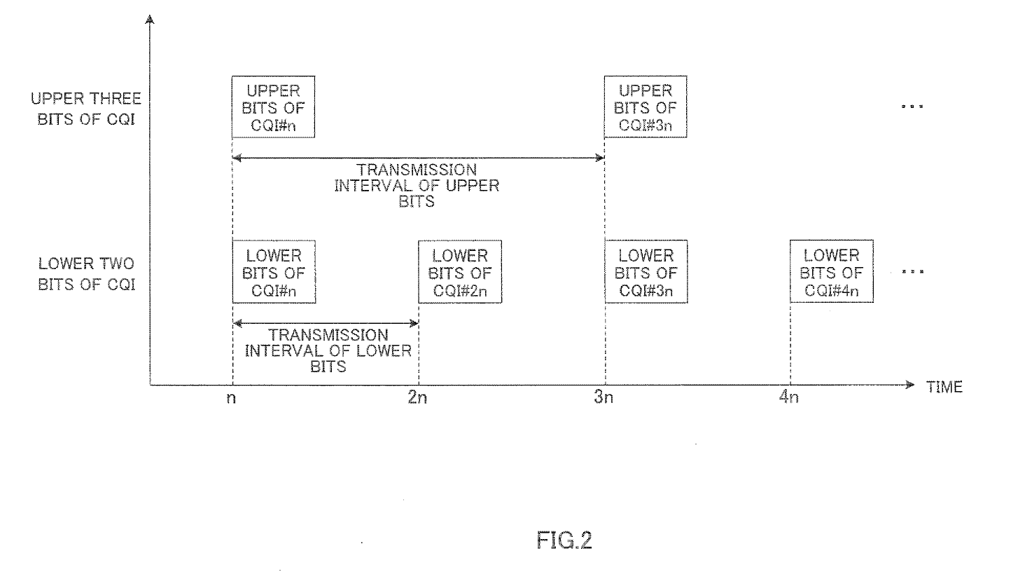

Lower bit transmission control section 105 sets the transmission interval of the lower two bits of the CQI to time interval n as illustrated in FIG. 2. That is, lower bit transmission control section 105 decides times n, 2n, 3n, 4n, and the like as the transmission time of the lower two bits of the CQI as illustrated in FIG. 2.

However, upper bit transmission control section 104 sets the transmission interval of the upper three bits of the CQI to time interval 2n as illustrated in FIG. 2. That is, upper bit transmission control section 104 decides times n, 3n, and the like as the transmission time of the upper three bits of the CQI as illustrated in FIG. 2.

As described above, upper bit transmission control section 104 sets the transmission interval of CQI-upper bits to be longer than the transmission interval of CQI-lower bits. Specifically, upper bit transmission control section 104 sets the transmission interval of the upper three bits of the CO to be twice the transmission interval of the lower two bits of the CQI as illustrated in FIG. 2. That is, upper bit transmission control section 104 sets the frequency of transmission of CQI-upper bits to be lower than the frequency of transmission of CQI-lower bits. For example, during the time interval 2n of from time n to time 3n illustrated in FIG. 2, the lower two bits of the CQI is transmitted twice, but the upper three bits of the CQI are transmitted only once which is smaller than the case of the lower two bits.

Thus, as illustrated in FIG. 2, upper three bits and lower two bits of CQI #n, that is, all bits of CQI #n are transmitted at time n, and only the lower two bits of CQI #2n are transmitted at time 2n. Similarly, upper three bits and lower two bits of CQI #3n, that is, all bits of CQI #3n are transmitted at time 3n, and only the lower two bits of CQI #4n are transmitted at the time 4n.

As described above, among a plurality of bits of a CQI, the higher the bit is, the less frequently the value changes. That is, the higher a CQI bit is, the slower a change in a value by channel variation is. For example, the values of the lower two bits of the CQI illustrated in FIG. 2 are likely to change at the time interval n (for example, between time n and time 2n). On the other hand, there is a possibility that the values of the upper three bits of the CQI illustrated in FIG. 2 will change at the time interval 2n (for example, between time n and time 3n), but a possibility that the values will change at the time interval n (for example, between time n and time 2n or between time 2n and time 3n) is low.

Thus, even through the transmission interval of CQI-upper bits (the upper three bits of the CQI in FIG. 2) is longer than the transmission interval of CQI-lower bits (the lower two bits of the CQI in FIG. 2) (even though the frequency of transmission of CQI-upper bits is lower than the frequency of transmission of CQI-lower bits), the degree of accuracy of the CQI used at each transmission time of the CQI is not lowered in the receiving apparatus that receives the CQI transmitted from transmitting apparatus 100. For example, in FIG. 2, the receiving apparatus can accurately select the transmission rate, at time 2n at which the upper three bits of the CQI are not transmitted, even by using a CQI of five bits including the upper three bits of CQI #n received at time n and the lower two bits of CQI #2n received at time 2n. That is, even though the transmission interval of CQI-upper bits is longer than the transmission interval of CQI-lower bits (even though the frequency of transmission of CQI-upper bits is lower than the frequency of transmission of CQI-lower bits), the overall accuracy of the CQI deteriorates little, and thus a possibility that the throughput will be lowered is low.

As described above, according to the present embodiment, the transmission interval of CQI-upper bits (that is, the transmission rate request signal) is set to be longer than the transmission interval of the lower bits by the transmitting apparatus. As a result, the transmitting apparatus can reduce the amount of CQI information by the degree in which the frequency of transmission of CQI-upper bits is smaller than the frequency of transmission of the lower bits. Further, the receiving apparatus has a reception interval of CQI-upper bits longer than the reception interval of the lower bits. However, since the values of CQI-upper bits change little, the receiving apparatus can select an adequate transmission rate, for example, using the CQI including the upper bits of the previously received CQI. That is, even when the transmitting apparatus sets the transmission interval of CQI-upper bits to be longer than the transmission interval of CQI-lower bits (that is, even when the frequency of transmission of CQI-upper bits is lower than the frequency of transmission of CQI-lower bits), the throughput is not lowered. Thus, according to the present embodiment, the amount of CQI information can be reduced without lowering the throughput. That is, according to the present embodiment, since the amount of CQI information is reduced, power consumption for the CQI can be reduced, and the amount of interference from CQIs against other terminals can be reduced.

Further, according to the present embodiment, the transmitting apparatus can reduce the amount of CQI information by controlling the transmission interval (the transmission frequency) of the upper bits and CQI-lower bits without changing the format of the CQI.

Further, the present embodiment has been described in connection with the case in which the CQI is represented by five bits and the transmitting apparatus divides the five bits into the upper three bits and the lower two bits. However, with the present invention, the number of bits representing the CQI is not limit to five. Further, the number of upper bits and the number of lower bits of the CQI are not limited to three and two, respectively. For example, when the CQI is represented by five bits, two bits may be used as the upper bits, and three bits may be used as the lower bits. Alternately, four bits may be used as the upper bits, and 1 bit may be used as the lower bit.

Further, the present embodiment has been described in connection with the case in which the transmission interval of CQI-upper bits is twice the transmission interval of CQI-lower bits. However, with the present invention, the transmission interval of CQI-upper bits is not limited to twice the transmission interval of CQI-lower bits, and the transmission interval of CQI-upper bits may be three times or four times the transmission interval of CQI-lower bits. That is, it is preferable that the transmission interval of CQI-upper bits is longer than the transmission interval of CQI-lower bits.

Further, the present embodiment has been described in connection with the case in which the transmitting apparatus divides a plurality of bits representing the CQI into two types of the upper bit and the lower bit. However, a plurality of bits representing a CQI does not necessarily have to be divided into two types and may be divided into three or more types. For example, when the CQI represented by five bits is divided into three, the transmitting apparatus may transmit one least significant bit at the transmission interval n, transmit two bits of second and third bits from the least significant bit at the transmission interval 2n, and transmit the remaining upper two bits at the transmission interval 4n.

### Embodiment 2

In the present embodiment, the transmitting apparatus sets the transmission interval of CQI-upper bits on a variable basis.

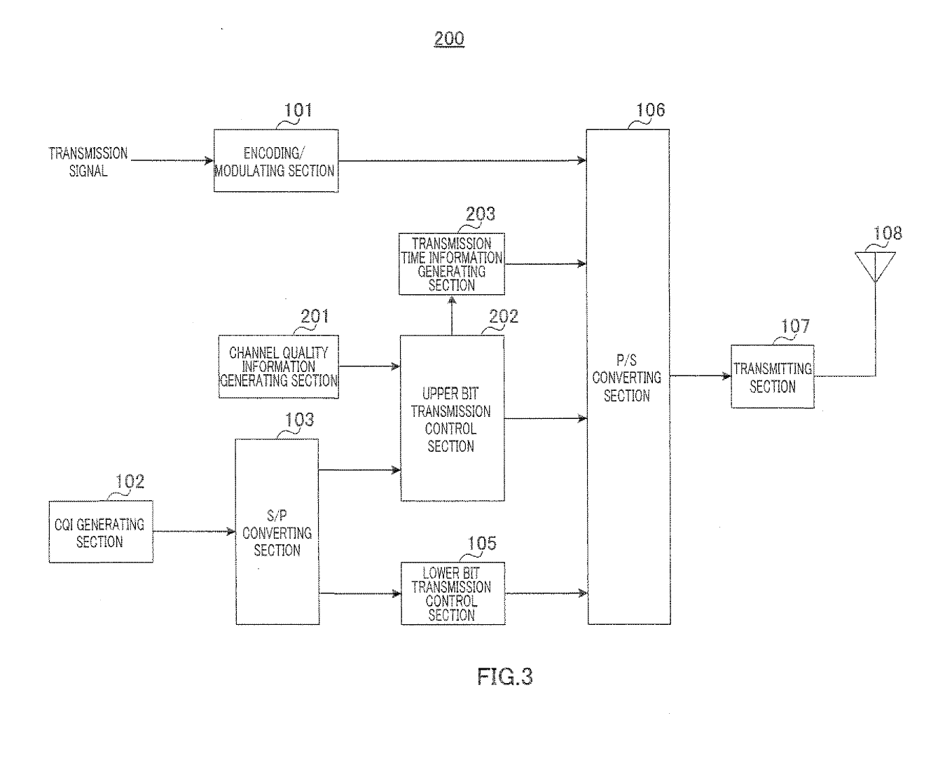

FIG. 3 illustrates a configuration of transmitting apparatus 200 according to the present embodiment. In FIG. 3, the same components as in Embodiment 1 (FIG. 1) are denoted by the same reference numerals, and a description thereof will not be repeated.

In transmitting apparatus 200 illustrated in FIG. 3, channel quality information generating section 201 generates channel quality information representing a rate of channel variation based on a channel quality (for example, a channel quality estimated by an estimating section (not shown)) between transmitting apparatus 200 and a receiving apparatus. For example, the rate of channel variation is calculated based on the amount of change of the estimation result of channel quality. Then, channel quality information generating section 201 outputs the generated channel quality information to upper bit transmission control section 202.

Upper bit transmission control section 202 decides the transmission time of CQI-upper bits based on the channel quality information input from channel quality information generating section 201. Specifically, upper bit transmission control section 202 sets the transmission interval of CQI-upper bits on a variable basis according to the rate of channel variation represented by the channel quality information. For example, upper bit transmission control section 202 sets a shorter transmission interval of CQI-upper bits when the rate of channel variation increases (when channel variation is significant). Similar to Embodiment 1, upper bit transmission control section 202 sets the transmission interval of CQI-upper bits to be longer than the transmission interval of CQI-lower bits. Then, upper bit transmission control section 202 outputs CQI-upper bits to P/S converting section 106 based on the set transmission interval. Further, upper bit transmission control section 202 outputs information representing a time for outputting CQI-upper bits to P/S converting section 106, that is, the transmission time for transmitting CQI-upper bits to transmission time information generating section 203.

Transmission time information generating section 203 generates transmission time information representing whether or not CQI-upper bits are to be transmitted at each time of the CQI based on the information representing the transmission time input from upper bit transmission control section 202. For example, transmission time information generating section 203 generates one bit (0 or 1) representing the presence and absence of transmission of CQI-upper bits as the transmission time information. Then, transmission time information generating section 203 outputs the generated transmission time information to P/S converting section 106.

P/S converting section 106 generates a signal of one system including a transmission signal, either of the CQI-upper bits and the CQI-lower bits, and the transmission time information input from transmission time information generating section 203. As a result, transmitting section 107 transmits a signal including the transmission time information representing whether or not CQI-upper bits are to be transmitted through antenna 108.

Meanwhile, when the transmission time of CQI-upper bits is set on a variable basis by upper bit transmission control section 202 of transmitting apparatus 200, the receiving apparatus needs to specify the transmission time of CQI-upper bits. The receiving apparatus judges the presence and absence of CQI-upper bits at each transmission time of the CQI based on the transmission time information included in the signal transmitted from transmitting apparatus 200.

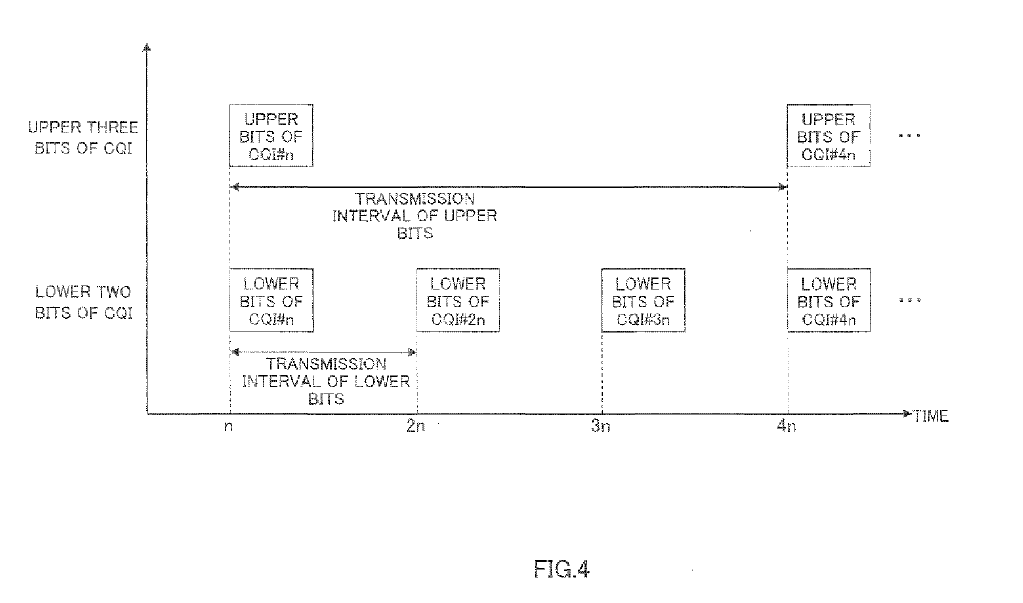

Next, a detailed description will be made in connection with a transmission control process by upper bit transmission control section 202 of transmitting apparatus 200. In the following description, similar to Embodiment 1, it is assumed that the number of CQI bits is five, three bits from a most significant bit among the five bits are used as the upper bits, and two bits from a least significant bit among the five bits are used as the lower bits. Further, similar to Embodiment 1, lower bit transmission control section 105 decides times n, 2n, 3n, 4n, and the like as the transmission time of the lower two bits of the CQI as illustrated FIGS. 2 and 4. That is, the transmission interval of CQI-lower bits is set to the time interval n similar to Embodiment 1.

For example, when the rate of channel variation represented by the channel quality information input from channel quality information generating section 201 is equal to or more than a previously set threshold value (when the rate of channel variation is relatively fast), upper bit transmission control section 202 sets the transmission interval of the upper three bits of the CQI to time interval 2n as illustrated in FIG. 2. That is, upper bit transmission control section 202 sets the transmission interval of the upper three bits of the CQI to be twice the transmission interval of the lower two bits of the CQI.

On the other hand, when the rate of channel variation is less than the previously set threshold value (when the rate of channel variation is relatively slow), upper bit transmission control section 202 sets the transmission interval of the upper three bits of the CQI to time interval 3n as illustrated in FIG. 4. That is, upper bit transmission control section 202 sets the transmission interval of the upper three bits of the CQI to be three times the transmission interval of the lower two bits of the CQI.

As described above, upper bit transmission control section 202 sets the transmission interval of the upper three bits of the CQI on a variable basis to either the time interval 2n (FIG. 2) or the time interval 3n (FIG. 4) according to the rate of channel variation.

Here, when the rate of channel variation increases (when channel variation is significant), a possibility that the CQI will frequently change is high, and thus transmitting apparatus 200 needs to increase the frequency of transmission of the CQI by further shortening the transmission interval of CQI-upper bits. Meanwhile, as the rate of channel variation decreases (the channel variation is moderate), a possibility that the CQI will change less is high. In this case, even though transmitting apparatus 200 reduces the transmission frequency by further making the transmission interval of CQI-upper bits longer, the receiving apparatus can select the transmission rate using the accurate CQI.

As described above, according to the present embodiment, the transmitting apparatus sets the transmission interval of CQI-upper bits on a variable basis according to the rate of channel variation. As a result, since the transmitting apparatus transmits CQI-upper bits as much as required according to the channel state at each time, the amount of CQI information can be further reduced compared to Embodiment 1.

Further, in the present embodiment, the transmitting apparatus transmits the information (the transmission time information) representing whether or not CQI-upper bits are to be transmitted, and thus the amount of information for transmitting the CQI increases with transmission time information. However, according to the present embodiment, the transmitting apparatus preferably transmits the transmission time information representing the presence and absence of transmission only with respect to CQI-upper bits. That is, just one bit (“0” or “1” representing the presence and absence of transmission of CQI-upper bits) is used as the amount of information necessary for transmission time information. Thus, the transmitting apparatus can improve the effect of reducing CQI information more than the performance deterioration caused by the increase of the amount of information with transmission time information by adequately setting the transmission interval of CQI-upper bits. That is, in the present embodiment, influence of performance deterioration by the increase of the amount of information with transmission time information is extremely small.

Further, in the present embodiment, the transmitting apparatus sets only the transmission interval of CQI-upper bits on a variable basis. For example, the base station including the receiving apparatus may perform resource management using the CQI (the transmission rate request signal). In this case, for example, if the transmitting apparatus varies the transmission interval of all bits of the CQI, the resource management by the base station becomes complicated. However, the transmitting apparatus variably sets only the transmission interval of CQI-upper bits as in the present embodiment, and thus the base station can perform the resource management using only CQI-lower bits. That is, the base station performs the resource management using only CQI-lower bits received at the fixed time (the transmission interval), whereby the resource management can be prevented from being complicated.

Further, the present embodiment has been described in connection with the case in which transmitting apparatus sets the transmission interval of CQI-upper bits to be twice (FIG. 2) or three times (FIG. 4) the transmission interval of CQI-lower bits according to the rate of channel variation. However, with the present invention, the transmission interval of CQI-upper bits set by transmitting apparatus according to the rate of channel variation is not limited to twice or three times the transmission interval of CQI-lower bits and may be set to an arbitrary value.

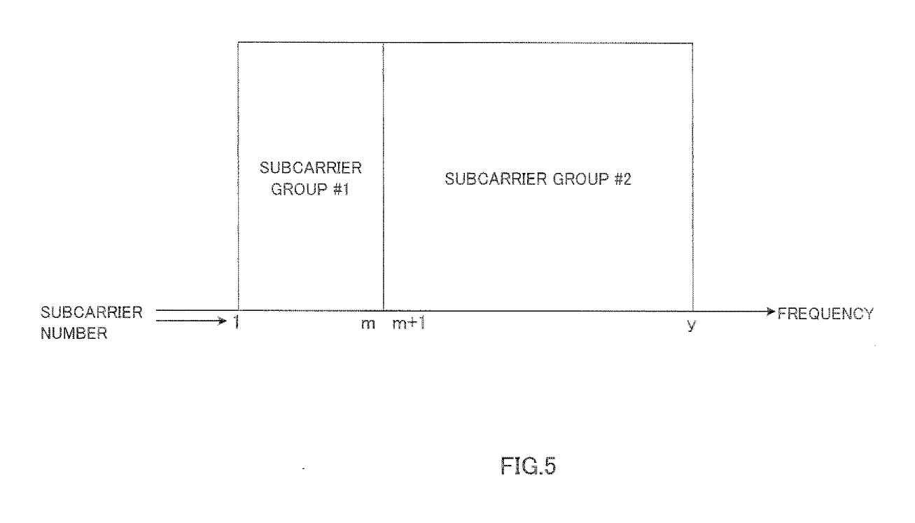

Further, in the present embodiment, when a multicarrier communication scheme such as an orthogonal frequency division multiplexing (OFDM) communication scheme is used, a transmitting apparatus (that is, OFDM transmitting apparatus) may group a plurality of subcarriers into a plurality of subcarrier groups and variably set the transmission interval of CQI-upper bits only for a certain subcarrier group among the plurality of subcarrier groups. For example, a description will be made in connection with a case in which a plurality of sub-carriers of subcarrier numbers 1 to y are grouped into subcarrier group #1 including subcarriers of subcarrier numbers 1 to in and subcarrier group #2 including subcarriers of subcarrier numbers (m+1) to y as illustrated in FIG. 5. In this case, the transmitting apparatus may variably set the transmission interval of CQI-upper bits only for certain subcarrier group #2. Further, the number of subcarrier groups is not limited to two illustrated in FIG. 5, and the plurality of subcarriers may be grouped into three or more (for example, 100) subcarrier groups.

Further, with the present invention, when a multiple-input multiple-output (MIMO) communication scheme is used, the transmitting apparatus may variably set the transmission interval of CQI-upper bits only for a certain antenna among a plurality of transmitting antennas. For example, the transmitting apparatus may variably set the transmission interval of CQI-upper bits received from a certain antenna according to the rate of channel variation of the certain antenna.

### Embodiment 3

The present embodiment will be described in connection with a transmission method of the CQI at the time of communication start.

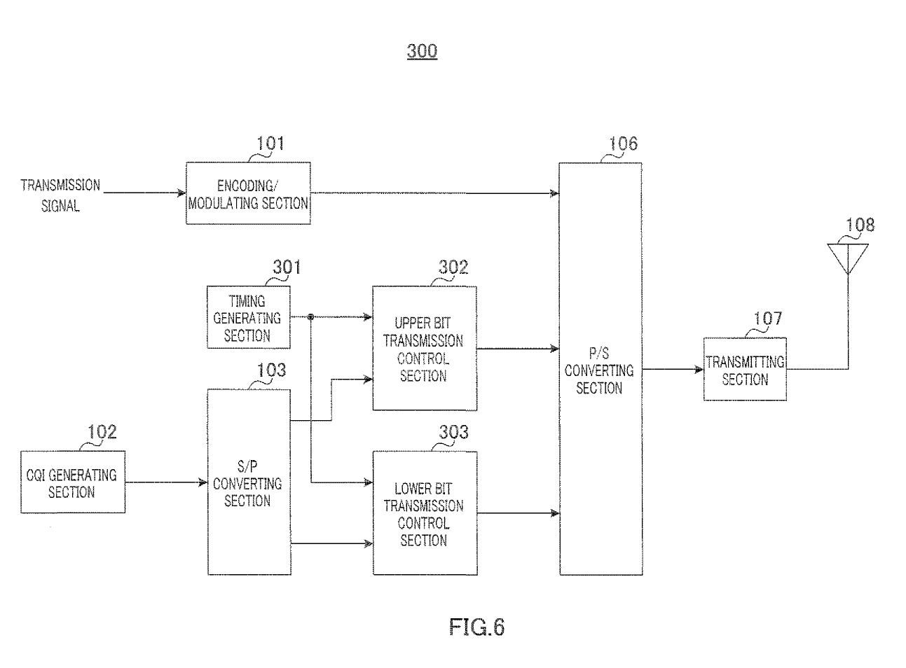

FIG. 6 illustrates a configuration of transmitting apparatus 300 according to the present embodiment. In FIG. 6, the same components as in Embodiment 1 (FIG. 1) are denoted by the same reference numerals, and a description thereof will be omitted.

Timing generating section 301 generates information representing timing of the communication start (a communication start time). Then, timing generating section 301 outputs the generated information to upper bit transmission control section 302 and lower bit transmission control section 303.

Upper bit transmission control section 302 sets the transmission interval of CQI-upper bits to be longer than the transmission interval of CQI-lower bits similar to upper bit transmission control section 104 (FIG. 1) of Embodiment 1. Further, upper bit transmission control section 302 decides the transmission time of CQI-upper bits based on the communication start time represented by the information input from timing generating section 301.

Lower bit transmission control section 303 decides the transmission time of CQI-lower bits based on the communication start time represented by the information input from timing generating section 301 similar to upper bit transmission control section 302.

Next, a detail description will be made in connection with a transmission control process by upper bit transmission control section 302 and lower bit transmission control section 303 of transmitting apparatus 300.

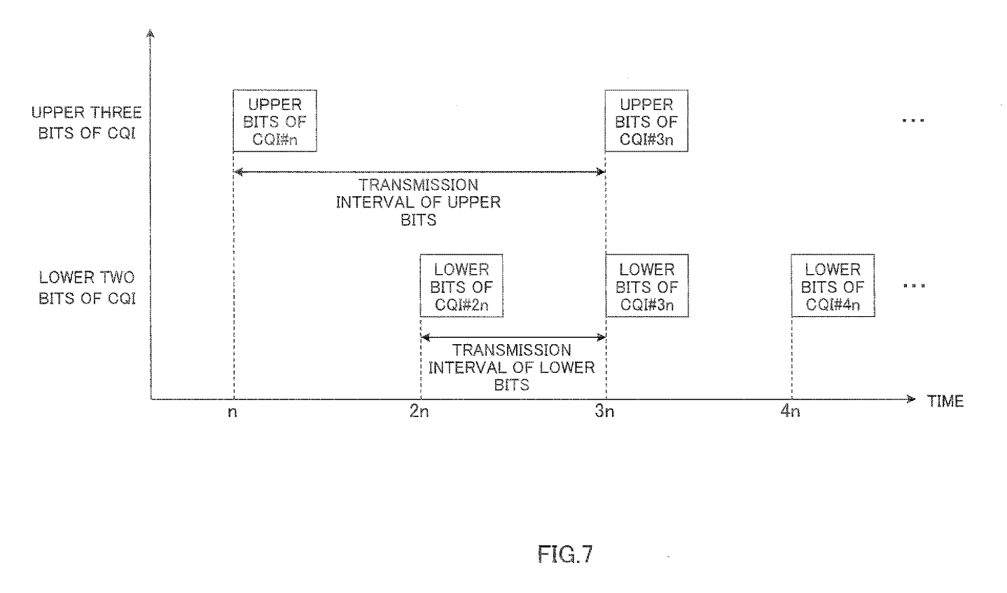

In the following description, similar to Embodiment 1, it is assumed that the number of CQI bits is five, three bits from the most significant bit among the five bits are used as the upper bits, and two bits from the least significant bit among the five bits are used as the lower bits. Further, it is assumed that the communication start time of transmitting apparatus 300 is set to a time n illustrated in FIGS. 2 and 7. Further, it is assumed that the transmission interval of the upper three bits of the CQI is set to time interval 2n, and the transmission interval of the lower two bits of the CQI is set to time interval n similar to Embodiment 1 as illustrated in FIGS. 2 and 7. That is, the transmission interval of the upper three bits of the CQI is set to be twice the transmission interval of the lower two bits of the CQI.

Transmission methods 1 and 2 of the CQI at the communication start time will be described below.

<Transmission Method 1>

In the present transmission method, transmitting apparatus 300 transmits the upper bits and CQI-lower bits, that is, all bits of the CQI at the communication start time.

Specifically, upper bit transmission control section 302 decides a time of every time interval 2n from the communication start time n as the transmission time of the upper three bits of the CQI as illustrated in FIG. 2. That is, upper bit transmission control section 302 decides times n, 3n, and the like as the transmission time of the upper three bits of the CQI as illustrated in FIG. 2.

Further, lower bit transmission control section 303 decides a time of every time interval n from the communication start time n as the transmission time of the lower two bits of the CQI as illustrated in FIG. 2. That is, lower bit transmission control section 303 decides times n, 2n, 3n, 4n, and the like as the transmission time of the lower two bits of the CQI as illustrated in FIG. 2.

That is, transmitting apparatus 300 (transmitting section 107) transmits all bits (five bits) of the CQI at the communication start time (time n) represented by the information input from timing generating section 301 as illustrated in FIG. 2.

Here, since a channel error is present in an actual channel, when a channel error occurs in the CQI transmitted from transmitting apparatus 300, the receiving apparatus (the base station) is likely to select the transmission rate different from the transmission rate requested by transmitting apparatus 300. Thus, a method in which the receiving apparatus averages the CQI multiple times is considered so as to avoid a transmission rate selection error by the channel error of the CQI. However, the number of CQI samples received in receiving apparatus is small at the time of communication start. Particularly, since the transmission interval of CQI-upper bits is longer than the transmission interval of the lower bits and the number of samples of CQI-upper bits is small, a CQI averaging effect is not obtained, and a probability of the transmission rate selection error increases.

However, in the present transmission method, transmitting apparatus 300 transmits all bits of the CQI at the time of communication start, and thus the receiving apparatus can use all bits of the CQI. Thus, according to the present transmission method, the probability of the transmission rate selection error can be prevented from increasing.

Further, according to the present transmission method, similar to Embodiment 1, since the amount of CQI information is reduced, power consumption for the CQI can be reduced, and the amount of interference from CQIs against other terminals can be reduced.

Further, the present transmission method has been described in connection with the case in which transmitting apparatus 300 transmits all bits of the CQI at the communication start time. However, with the present invention, a time at which all bits of the CQI are transmitted is not limited to the communication start time. For example, the transmitting apparatus may transmit all bits of the CQI at a time at which the rate of channel variation is fast, that is, at a time at which a change in the value of a CQI is severe.

<Transmission Method 2>

In the present transmission method, transmitting apparatus 300 transmits only CQI-upper bits at the communication start time.

Specifically, upper bit transmission control section 302 decides a time of every time interval 2n from the communication start time n as the transmission time of the upper three bits of the CQI similar to Transmission Method 1 (FIG. 2) as illustrated in FIG. 7. That is, upper bit transmission control section 302 decides times n, 3n, and the like as the transmission time of the upper three bits of the CQI as illustrated in FIG. 7.

On the other hand, lower bit transmission control section 303 decides a time of every time interval n from time 2n as the transmission time of the lower two bits of the CQI as illustrated in FIG. 7. That is, lower bit transmission control section 303 decides times 2n, 3n, 4n, and the like as the transmission time of the lower two bits of the CQI as illustrated in FIG. 7. That is, lower bit transmission control section 303 does not set the communication start time n as the transmission time of the lower two bits of the CQI.

That is, transmitting apparatus 300 (transmitting section 107) transmits only the upper bits (the upper three bits) of the CQI at the communication start time (time n) represented by the information input from timing generating section 301 as illustrated in FIG. 7.

Thus, the receiving apparatus receives only the upper three bits among the five bits of the CQI at the communication start time (time n illustrated in FIG. 7). That is, the CQI received by the receiving apparatus at the communication start time has an error corresponding to the lower two bits of the CQI compared to the value (the actual CQI generated by CQI generating section 102) represented by all bits (five bits) of the CQI.

However, among a plurality of bits representing the CQI, the lower a CQI bit is, the smaller the representable value is. Thus, influence of the error corresponding to the lower two bits of the CQI on the value of the entire CQI is small. That is, the receiving apparatus can receive the upper three bits of the CQI at the communication start time and specify a rough value of the CQI. Thus, the receiving apparatus is unable to specify the accurate value of the CQI since the lower two bits of the CQI are not received at the communication start time but can almost accurately select the transmission rate using the upper three bits of the CQI (the rough value of the CQI).

As described above, according to the present transmission method, transmitting apparatus 300 transmits only CQI-upper bits at the communication start time and thus can further reduce the amount of CQI information compared to Embodiment 1. Further, at the communication start time, the receiving apparatus is unable to specify the accurate CQI but can specify the rough value of the CQI, and thus the receiving apparatus can almost accurately select the transmission rate. Thus, according to the present transmission method, the amount of CQI information can be further reduced without lowering the throughput.

CQI transmission methods 1 and 2 at the communication start time have been described above.

As described above, according to the present embodiment, even when the transmitting apparatus decides the transmission time of the CQI based on the communication start time, the amount of CQI information (the transmission rate request signal) can be reduced without lowering the throughput, similar to Embodiment 1.

### Embodiment 4

In the present embodiment, the transmitting apparatus transmits all bits of the CQI at a time at which the most significant bit of the CQI changes.

The most significant bit among a plurality of bits representing the CQI has a largest representable value. Further, there is a high possibility that all bits except the most significant bit of the CQI will change at a time when the most significant bit of the CQI changes. For example, in a CQI of five bits, when one value in the CQI of “01111” increases, the value of a CQI changes to “10000.” Thus, the most significant bit of the CQI changes from “0” to “1,” and all bits except the most significant bit of the CQI change from “1111” to “0000.” It is similarly applied even when the CQI changes from “10000” to “01111.”

Here, when the transmitting apparatus has set the transmission interval of CQI-upper bits to be longer than the transmission interval of CQI-lower bits as described above, the most significant bit of the CQI generated at a time other than the transmission time of CQI-upper bits may change from the most significant bit of the previously generated CQI. That is, the most significant bit of the CQI may not be transmitted at a time at which the most significant bit of the CQI changes (that is, a time at which all bits except the most significant bit of the CQI can change). In this case, the receiving apparatus specifies the received CQI as a value completely different from the actual CQI and selects the transmission rate different from the transmission rate actually requested by the transmitting apparatus.

For this reason, in the present embodiment, the transmitting apparatus transmits all bits of the CQI at a time at which the most significant bit of the CQI changes.

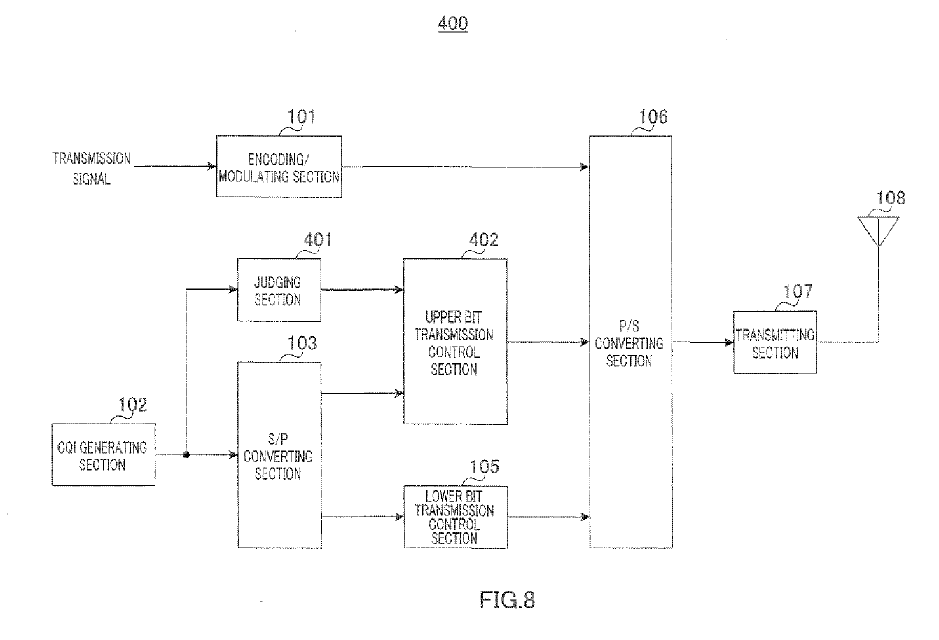

FIG. 8 illustrates a configuration of transmitting apparatus 400 according to the present embodiment. In FIG. 8, the same components as in Embodiment 1 (FIG. 1) are denoted by the same reference numerals, and a description thereof will be omitted.

In transmitting apparatus 400 illustrated in FIG. 8, judging section 401 judges whether or not the value of the most significant bit among a plurality of bits representing the CQI has changed using the CQIs sequentially input from CQI generating section 102. Then, when it is judged that the value of the most significant bit of the CQI has changed, judging section 401 instructs upper bit transmission control section 402 to transmit CQI-upper bits.

Upper bit transmission control section 402 sets the transmission interval of CQI-upper bits to be longer than the transmission interval of CQI-lower bits similar to upper bit transmission control section 104 (FIG. 1) of Embodiment 1. Further, when judging section 401 has instructed upper bit transmission control section 402 to transmit CQI-upper bits at a certain time, upper bit transmission control section 402 decides the time as the transmission time of CQI-upper bits.

That is, transmitting apparatus 400 (transmitting section 107) necessarily transmits CQI-upper bits at a time at which the value of the most significant bit of the CQI changes. As a result, the receiving apparatus can receive all bits of the CQI at a time at which the most significant bit of the CQI changes. That is, the receiving apparatus can reliably select the appropriate transmission rate, using the CQI on which the latest channel state is reflected, at a time at which the most significant bit of the CQI changes.

Further, when the most significant bit of the CQI has changed, transmitting apparatus 400 needs to notify the receiving apparatus of transmission of all bits of the CQI regardless of the transmission interval set to CQI-upper bits. To this end, transmitting apparatus 400 transmits, to the receiving apparatus, control information representing whether or not the most significant bit of the CQI has changed (whether or not all bits of the CQI are to be transmitted at a time other than the transmission time set to CQI-upper bits). However, the control information can be represented by one bit (0 or 1) representing the presence and absence of a change in the most significant bit of the CQI, and thus an increase of the amount of information can be minimized. That is, transmitting apparatus 400 appropriately sets the transmission interval of CQI-upper bits and improves the effect of reducing the amount of CQI information, similar to Embodiment 2, so that it is possible to reduce the influence of performance deterioration by the increase of the amount of control information.

As described above, according to the present embodiment, the transmitting apparatus transmits all bits of the CQI at a time at which the most significant bit of the CQI changes. As a result, the receiving apparatus can receive the accurate CQI even at the time at which the most significant bit of the CQI changes, and thus it is possible to prevent the transmission rate different from the transmission rate actually requested by transmitting apparatus from being wrongly selected. Further, according to the present embodiment, the amount of CQI information can be further reduced without lowering the throughput at a time other than a time at which the most significant bit of the CQI changes similar to Embodiment 1.

Embodiments of the present invention have been described above.

With the present invention, the transmitting apparatus may set the transmission interval of CQI-upper bits and the transmission interval of CQI-lower bits, respectively, for example, according to when the channel state has changed better or when the channel state has changed poorer. For example, when the channel state has changed poorer, the transmitting apparatus sets the transmission interval of CQI-upper bits to be twice the transmission interval of CQI-lower bits as illustrated in FIG. 2. However, when the channel state has changed better, the transmitting apparatus sets the transmission interval of CQI-upper bits to be three times the transmission interval of CQI-lower bits as illustrated in FIG. 4. That is, the transmission interval of CQI-upper bits when the channel state has changed poorer is shorter than the transmission interval of CQI-lower bits when the channel state has changed better. Thus, when the channel state has changed poorer, the channel error of the CQI can be prevented from occurring, and additional retransmission can be prevented from occurring. On the other hand, when the channel state has changed better, the amount of CQI information can be further reduced.

Further, with the present invention, the transmitting apparatus may set the transmission interval of CQI-upper bits and the transmission interval of CQI-lower bits for each subcarrier group. For example, when a multicarrier communication scheme such as an OFDM communication scheme is used, the transmitting apparatus (that is, OFDM transmitting apparatus) may group a plurality of subcarriers into a plurality of subcarrier groups and set the transmission interval of CQI-upper bits and the transmission interval of CQI-lower bits for each subcarrier group. For example, the transmitting apparatus may set the transmission interval of CQI-upper bits to be twice the transmission interval of CQI-lower bits for subcarrier group #1 illustrated in FIG. 5 as illustrated in FIG. 2, whereas the transmitting apparatus may set the transmission interval of CQI-upper bits to be three times the transmission interval of CQI-lower bits for subcarrier group #2 illustrated in FIG. 5 as illustrated in FIG. 4. As described above, the transmitting apparatus independently sets the appropriate transmission interval for each subcarrier and reduces the amount of CQI information for each subcarrier. Thus, power consumption for the CQI can be reduced, and the amount of interference from CQIs against other terminals can be reduced.

Further, in the present embodiment, when a MIMO communication scheme is used, the transmitting apparatus may set the transmission interval of CQI-upper bits and the transmission interval of CQI-lower bits for each transmitting antenna. A transmitting apparatus (not shown) including a plurality of transmitting antennas of a transmitting antenna 1 and a transmitting antenna 2 will be described as an example. The transmitting apparatus may set the transmission interval of CQI-upper bits to be twice the transmission interval of CQI-lower bits for the transmitting antenna 1 as illustrated in FIG. 2, whereas the transmitting apparatus may set the transmission interval of CQI-upper bits to be three times the transmission interval of CQI-lower bits for the transmitting antenna 2 as illustrated in FIG. 4. As described above, the transmitting apparatus independently sets the appropriate transmission interval for each transmitting antenna and reduces the amount of CQI information for each transmitting antenna. Thus, power consumption for the CQI can be reduced, and the amount of interference from CQIs against other terminals can be reduced.

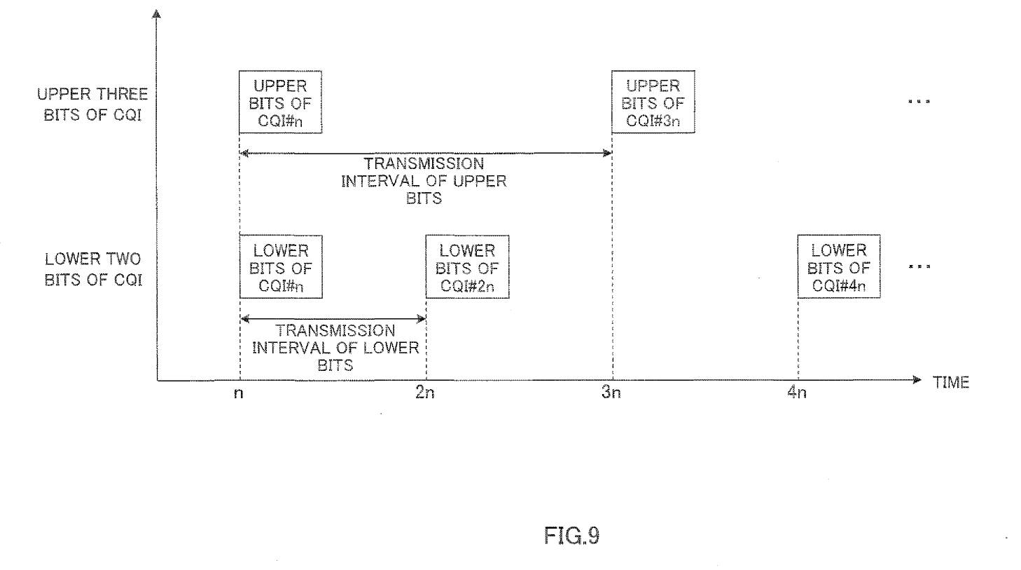

Further, in the present embodiment, the transmitting apparatus may transmit only CQI-upper bits at a certain time as illustrated in FIG. 9 (time 3n in FIG. 9). By transmitting only CQI-upper bits at a certain time, the amount of CQI information can be reduced, and power consumption for the CQI and the amount of interference from CQIs against other terminals can be further reduced. Further, the transmitting apparatus may transmit only CQI-upper bits only for a certain subcarrier group when a multicarrier communication scheme such as an OFDM communication scheme is used. Further, the transmitting apparatus may transmit only CQI-upper bits only for a certain transmitting antenna when a MIMO communication scheme is used.

Further, with the present invention, a communication terminal apparatus or a base station apparatus may be used as the transmitting apparatus according to the present embodiment. Thus, the communication terminal apparatus and the base station apparatus having the aforementioned operation and effects can implement a mobile communication system.

The disclosure of Japanese Patent Application No. 2009-110931, filed on Apr. 30, 2009, including the specification, drawings and abstract, is incorporated herein by reference in its entirety.

### INDUSTRIAL APPLICABILITY

The present invention can be applied to a transmitting apparatus, a transmission method, and the like according to a communication scheme using a link adaptation in which an encoding rate or a modulating scheme varies according to a channel quality or the like.

### REFERENCE SIGNS LIST

100, 200, 300, 400 Transmission device
101 Encoding/modulating section
102 CQI generating section
103 S/P converting section
104, 202, 302, 402 Upper bit transmission control section
105, 303 Lower bit transmission control section
106 P/S converting section
107 Transmitting section
108 Antenna
201 Channel quality information generating section
203 Transmission time information generation section
301 Timing generating section
401 Judging section

1. A transmitting apparatus, comprising:
a control section that sets a first transmission interval of an upper bit of a control signal to be longer than a second transmission interval of a lower bit of the control signal; and
a transmitting section that transmits the control signal based on the set first transmission interval and the set second transmission interval.

2. The transmitting apparatus according to claim 1, wherein the control section sets the first transmission interval on a variable basis.

3. The transmitting apparatus according to claim 2, wherein the transmitting section transmits a signal showing whether or not the upper bit of the control signal is transmitted.

4. The transmitting apparatus according to claim 1, wherein the control section sets the first transmission interval and the second transmission interval, respectively, according to when channel state has changed better or when the channel state has changed poorer.

5. The transmitting apparatus according to claim 1, wherein the control section sets the first transmission interval and the second transmission interval per subcarrier.

6. The transmitting apparatus according to claim 1, further comprising a plurality of antennas,
wherein the control section sets the first transmission interval and the second transmission interval for each of the plurality of antennas.

7. The transmitting apparatus according to claim 1, wherein the transmitting section transmits all bits of the control signal at a time to start communication.

8. The transmitting apparatus according to claim 1, wherein the transmitting section transmits only the upper bit of the control signal at a time to start communication.

9. The transmitting apparatus according to claim 1, wherein the transmitting section transmits all bits of the control signal at a time a most significant bit of the control signal changes.

10. The transmitting apparatus according to claim 1, wherein the transmitting apparatus supports an orthogonal frequency division multiplexing communication scheme.

11. The transmitting apparatus according to claim 1, wherein the transmitting apparatus is a communication terminal apparatus or a base station apparatus.

12. A transmission method comprising:
setting a first transmission interval of an upper bit of a control signal to be longer than a second transmission interval of a lower bit of the control signal; and
transmitting the control signal based on the set first transmission interval and the set second transmission interval.
